(19) United States
(12) Patent Application Publication
(10) Pub. No.: US 2002/0088823 A1
(43) Pub. Date: Jul. 11, 2002

(54) Distribution control system for dispensing quality liquids

(75) Inventors: Otavio R. Tabacchi, Centennial, CO (US); Michael H. Smith, Castle Rock, CO (US); Thomas D. Liston, Aurora, CO (US)

Correspondence Address: SHERIDAN ROSS PC, 1560 BROADWAY, SUITE 1200, DENVER, CO, 80202

(73) Assignee: Secure Concepts, Ltd., Greenwood Village, CO

(21) Appl. No.: 10/038,254

(22) Filed: Oct. 19, 2001

Related U.S. Application Data
(60) Provisional application No. 60/241,581, filed on Oct. 19, 2000.
(60) Provisional application No. 60/241,701, filed on Oct. 19, 2000.

(51) Int. Cl. B67D 5/08

(52) U.S. Cl. 222/52

(57) ABSTRACT

A system and method for controlling the dispensing of a fluid is disclosed, wherein the following capabilities may be provided: (a) regulation of the times that such dispensing can occur, (b) determination of the quality of the fluid so that, e.g., poor quality fluids can be purged, and/or (c) control of the system remotely. The system and method of the invention may be used for the dispensing of fluids such as beer and other beverages. A valve assembly in a fluid dispensing line can be configured to dispense the fluid, re-route the line contents so that it is purged when the quality of the fluid therein is determined to be unacceptable, or stop all flow of the fluid through the line. Quality detectors are provided for detecting the quality of the fluid being dispensed. For the dispensing of beer, an optical foam detector is disclosed as one such quality detector for detecting and purging a beer dispensing line when the line is substantially foam rather than beer.

### RELATED FIELD OF THE INVENTION

The present invention relates to a controller for controlling the distribution and quality of a fluid, and in particular, to the dispensing of beverages having a predetermined quality.

### BACKGROUND

Dispensing and/or distributing liquids, and in particular, beverages can be unnecessarily expensive when the quality of the liquid flowing through distribution lines is less than satisfactory, and/or when there is insufficient control over when and how much of the liquid can be dispensed. In particular, when carbonated beverages such as beer are dispensed, there can be substantial waste due to less than satisfactory in beer quality, e.g., from excessive amounts of foam being dispensed. Such foamy beers are generally disliked by consumers. Moreover, since many beer dispensing establishments have beer dispensing lines for transferring the beer from a keg room to various beer taps, if such a line becomes filled with foam rather than beer, the entire line must purged and accordingly the beer in the foam is wasted, beer purchases are delayed, and personnel time is required to purge the foamy beer line. Additionally, there can be added expenses due to the dispensing of free glasses of beer. Such distributions of free beer can be a significant cost to the operator of the beer dispensing establishment.

Similar unnecessary expenses and/or wastage occur in the dispensing of other liquids such as water, wherein unauthorized access can increase expenses of, e.g., metropolitan water distribution facility. Moreover, if the water quality becomes degraded due to, e.g., contamination during distribution, then valve assemblies may be needed to purge and/or recycle the contaminated water.

Thus, it would be desirable to have a dispensing system for a liquid product, and in particular consumable liquids, wherein the dispensing system monitors and controls both the quality and the access to the product in a more cost-effective manner than is currently available.

### SUMMARY

The present invention is a controller/dispensing system that controls the dispensing of liquids that must or are preferred to meet one or more predetermined quality criteria and/or standards. In particular, the present invention monitors the quality of a liquid to be dispensed in a distribution line for determining the quality of the contents of the line, and actuating various valve assemblies depending on whether the quality criteria are met by the line contents. Thus, if a quality detector included in the controller/dispensing system determines that a change in the contents of its monitored distribution line has occurred, i.e., from satisfying the quality criteria to not satisfying such criteria or visa versa, then a corresponding valve assembly on the line is activated for re-routing the line contents. For example, the line contents may be rerouted from being distributed to an end user to being purged (alternatively recycled) in the case of a quality detector detecting a change to unsatisfactory distribution line contents, or, re-routed from being purged (alternatively re-cycled) in the case of a quality detector detecting a change to a satisfactory distribution line contents.

In one embodiment of present invention, such a quality detector detects a change in the amount of foam within a distribution line. Such foam detectors are particularly important in the distribution of certain beverages such as beer and other carbonated drinks where the presence of foam reduces the quality of the beverage being dispensed. Moreover, it is a further aspect of the present invention that it includes a foam detector that is substantially electronic and accordingly does not require disassembly for cleaning. In particular, embodiments of the invention may include an electronic foam detector that detects a change in the amount of foam optically.

It is also an aspect of the controller/dispensing system of the present invention to provide capabilities for a user to control the dispensing of a liquid within one or more distribution lines (e.g., a distribution network) according to user input schedules, wherein one or more valves on the distribution line(s) are opened for dispensing their contents or closed thereby stopping such dispensing. Accordingly, the dispensing of the liquid can be regulated according to an operator's input. Thus, dispensing of the liquid can be terminated at certain times, on certain days and/or due to operator input conditions. Accordingly, for the dispensing of beverages such as beer, such a regulating capability is important for, e.g., terminating the dispensing of beer late at night or after hours in that there can be a significant loss of such beverages by employees and others who have access to beverage dispensers and do not pay for the beverages they consume therefrom.

Additionally, the present invention may include one or more metering devices for determining the amount of liquid dispensed to end users (and/or purged).

There are numerous applications for embodiments of the present invention. In addition to the controlling the dispensing of quality beverages. Other embodiments may be used for monitoring the quality of and controlling the distribution of water such as in a rural or metropolitan water distribution network. Other applications are for detecting contaminants in non-opaque liquids such as: oil, carbonated water, milk products, syrups, wine, cooking oils, liquid dough, liquid medicines, liquid pesticides, liquid herbicides, automotive oils, natural and synthetic oils, liquid soap, and grease (both industrial and eatable).

Other features and benefits of the present invention will become evident from the accompanying drawing and the Detailed Description hereinbelow.

### BRIEF DESCRIPTION OF THE DRAWINGS

FIG. 1 is a diagram showing the high level components of an embodiment of the dispensing control system 20 for dispensing a beverage.

FIG. 2 is a more detailed diagram of the components of an embodiment of the beverage distribution control system 20 wherein a particular one of the beverage quality detector(s) 38, i.e., a foam detector 54, is shown.

FIG. 3 shows an illustration of an embodiment of the present invention as it may appear for dispensing beer from a keg room 90.

FIG. 4 is a flowchart of the steps performed in configuring an operable embodiment of the dispensing and control system 20 as represented in FIG. 1, and subsequently operating the configured embodiment.

FIG. 5 is a diagram illustrating the high level components of an optical foam detector 54 that can be used for detecting foam in a line 28 for dispensing a liquid such as beer or another beverage.

FIG. 6 is a flowchart of the high level steps performed when the foam detector 54 detects foam due to a depleted beverage source 32 such as a depleted beer keg.

### DETAILED DESCRIPTION

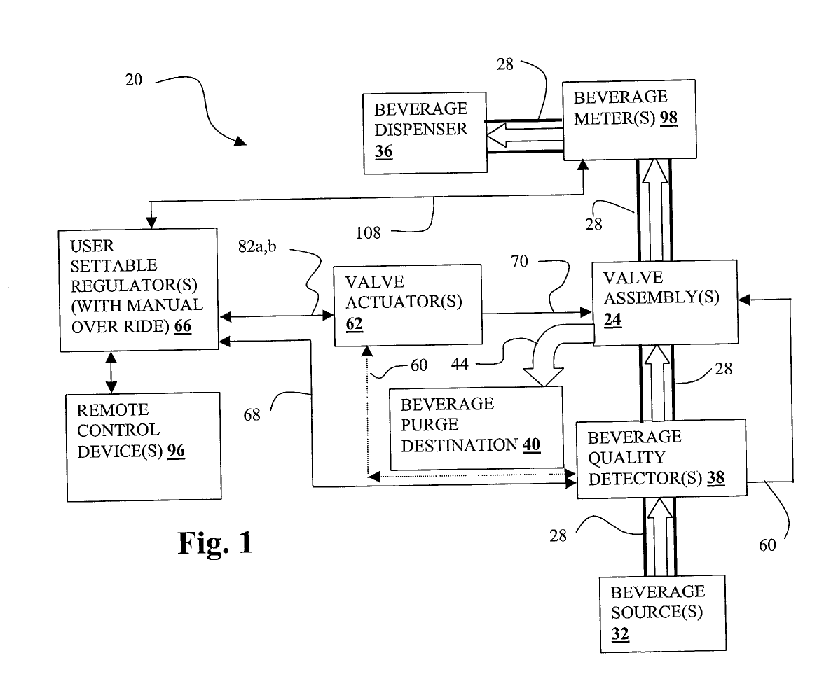

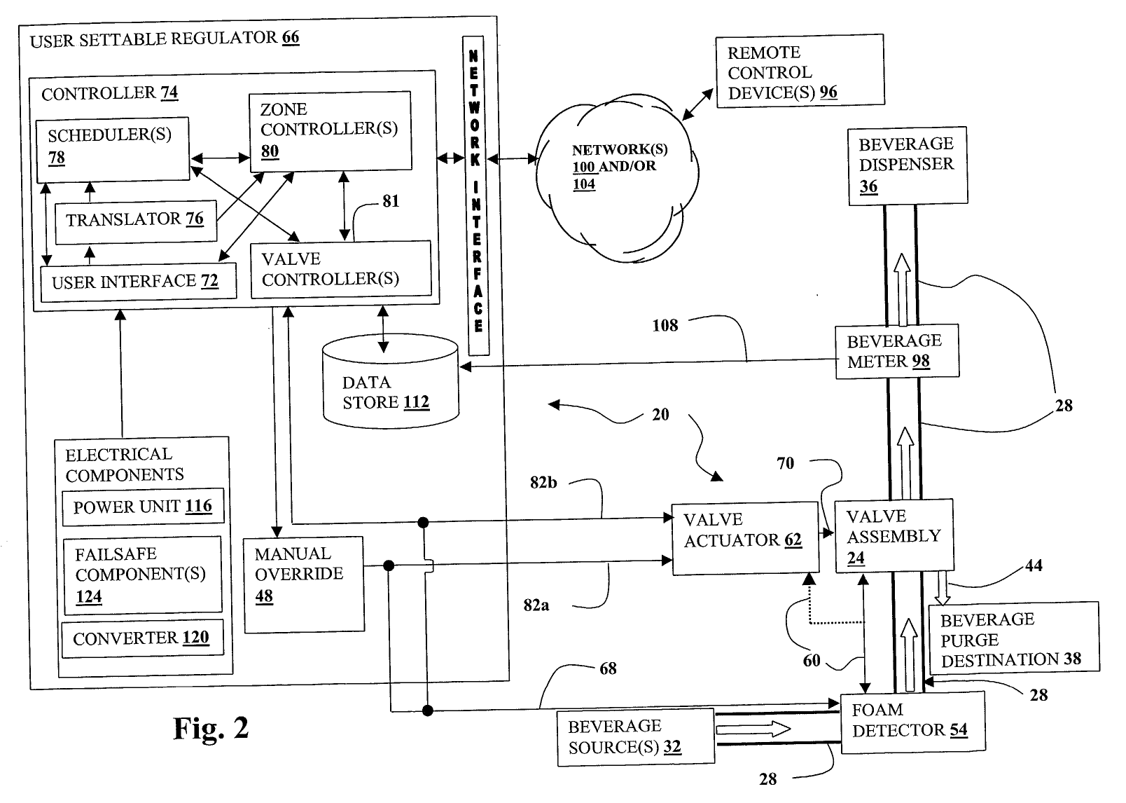

FIG. 1 shows a high level of the components of the beverage controller 20 of the present invention. Included within beverage controller 20 are one or more valve assemblies 24, each such valve assembly being for physically opening and shutting the flow of the beverage through a different beverage line 28, wherein each beverage line 28 transports a beverage from a corresponding beverage source 32 (e.g., a beer keg room) to a corresponding beverage dispenser 36 for dispensing the beverage within the line. Note that each of the valve assemblies 24 includes one or more valves (not separately shown in FIG. 1) so that in a first (open) mode the valve assembly allows its beverage to flow through to a connected one of the beverage dispensers 36 possibly monitored under the control of (any) beverage quality detector(s) 38 (described further hereinbelow), and in a second (shut) mode to explicitly stop such a beverage flow. However, in some embodiments the valve assemblies 24 may also enter a third (purge) mode, wherein an amount of beverage is purged from its line 28 and directed to a beverage purge destination 40 for disposal. For example, if air or foam is determined to be in the valve assembly's beverage line 28, then the valve assembly may enter such a third mode for purging the line 28, e.g., in response to user input directed explicitly to a current occurrence of air or foam in the line 28, and/or automatically via, e.g., signals from one of the beverage quality detector(s) 38 for detecting such beverage anomalies. Thus in purge mode, the contents of the line 28 are purged, via the purge line 44, to the beverage purge destination 40. This third (purge) mode may, in some embodiments, be also explicitly entered by a user via, e.g., a manual override 48 (FIG. 2) which is described further hereinbelow. However the purge mode may, in some embodiments of the beverage controller 20, be entered automatically in response to a signal provided by one of the beverage quality detector(s) 38, wherein such detectors monitor the quality of the beverage being supplied from the connected one or more of the beverage sources 32. Additionally, note that in some embodiments there is a purge mode timer (not shown), wherein this timer determines the length of time that the valve assembly 24 remains continuously in purge mode. This length of time is dependent upon the length of the line 28 between the connected beverage source 32 and the corresponding connected valve assembly 24. In particular, such detectors 38 can cause one or more of the valve assemblies 24 to transition from the first (open) mode to the purge and/or shut mode. Such beverage quality detectors 5638 may monitor, e.g., the carbonation of a beverage, the temperature of a beverage, and/or whether a current one of the beverage sources 32 has exhausted its supply of beverage (or a beverage constituent, e.g., a beverage syrup thereof). Moreover, note that the speed at which such a beverage quality detector 38 can detect a change in the state of the contents of its beverage line 28 can be an important in determining the extent of beverage line 28 contents to purge. Thus, the faster such a line contents change can be reliably detected the less beverage may be wasted due to purging. Accordingly, it is an aspect of the present invention to determine the length of the line 28 between a beverage quality detector 38 and a corresponding signaled valve assembly 24 as a function of the maximum (and/or typical) latency time required to reliably identify a beverage contents state change.

Moreover, note that in addition to the valve modes described above, other valve modes may also be provided; e.g., the open mode may be replaced by two modes: “controlled” and “explicitly open”. In the controlled mode a valve assembly 24 is controlled by one or more beverage quality detectors 38. In the explicitly open mode a valve assembly 24 is forced to be open regardless of any detector 38 signals that might request the closing thereof.

In one particularly important embodiment, one of the beverage quality detectors 38 includes a foam detector 54 (FIG. 2) for detecting foam in a beverage line 28. Various embodiments of foam detectors 54 can be incorporated into the present invention. In particular, there are various mechanical foam detectors that may be used. Note, however, that such mechanical foam detectors typically have the equivalent of a purge valve incorporated therein, and accordingly such a foam detector would likely be provided as part of a valve assembly 24. Alternatively, a foam detector 54 (or any other beverage quality detector 38) can be substantially electronic, wherein there may be a communication channel 60 for communicating with electronic components of a corresponding one of the valve actuators 62 (dashed arrow 60) and providing data that the actuator can use for determining how to transition a controlled valve assembly 24 between its modes of beverage flow. Note that in some embodiments, the valve actuator 62 and/or the valve assembly 24 may provide signals (via channel 60) to the foam detector 54 for deactivating the foam detector 54 during purge mode, and additionally reset signals may also be transmitted to the foam detector 54 for reactivation when the valve assembly 24 enters the open or controlled mode. Alternatively, depending on the sophistication of a valve assembly 24, the communication channel 60 may provide mode transitioning instructions directly to electronic components of such a valve assembly 24 (as indicated by the solid arrow 60). However, in yet another alternative embodiment of the beverage controller 20 (not shown in the figures) the communication channel 60 may transmit valve mode transition data to other components of the beverage controller 20. In particular, such mode transitioning data may be supplied to one of the user settable regulators 66, each of which provides high level control for one or more of the valve assemblies 24, and in particular, control for when and/or how much of a beverage can be dispensed by a corresponding one or more beverage dispensers 36 whose beverage line is regulated by the valve actuator. Thus, this regulator 66 would then communicate with the corresponding valve actuator 62 for transitioning a controlled valve assembly 24 between its modes of operation. The operation of a particular embodiment of the foam detector 54 in conjunction with other components of present invention is described further below.

Additionally, there may be a signal channel(s) 68 between a user settable regulator 66 and at least some of beverage quality detector(s) 38 having electronic interfaces thereto. In particular, such a channel 68 allows the regulator 66 to activate/deactivate particular beverage quality detectors 38 as well as receive signal feedback as to the status of such detectors 38. For example, regarding a foam detector 54 (FIG. 2) having such an electronic interface, the user settable regulator 66 may provide a user with the capability to deactivate the foam detector (e.g., when cleaning its line 28), and to reset the foam detector so that it subsequently detects foam in its line 28. Note, that signals on channel 68 may be transmitted from the manual override 48 and/or a controller 74 (described hereinbelow).

Note that each valve assembly 24 is controlled for entering the first (open), second (shut) and third (purge) modes by a corresponding valve actuator 62. Each of the valve actuator(s) 62 may electrically, pneumatically, hydraulically, or mechanically operate a corresponding one of the valve assemblies 24 via connector 70, as one skilled in the art will understand. In particular, if a valve assembly 24 is operated mechanically, hydraulically or pneumatically, then connector 70 can be a push rod(s), a hydraulic line(s) or a pneumatic line(s), respectively. Each of the valve actuators 62 is regulated by a corresponding one of the one or more user settable regulator 66 (FIGS. 1 and 2) that allows a user to configure, e.g., the high level control functions mentioned above. In particular, the user may enter one or more of the following inputs, via, e.g., the user interface 72 of a controller 74 (FIG. 2), depending on the embodiment of the beverage controller 20 being used:

(a) User friendly valve assembly 24 identification that allows a valve assembly to be identified by one or more user specified character strings and/or graphical symbols; e.g., a user may provide input for changing a output display identification of the valve assembly generically identified as “V22” so that it displays as “first floor bar beer valve (V22)”. Note that the translator 76 (FIG. 2) of the controller 66 provides this functionality.

(b) Data identifying which of one or more valve assemblies 24 whose times and/or modes of operation are to be input.

(c) A schedule (or input to remove, or to suspend a schedule) designating the times of the day and/or the days of the week when one or more valve assemblies 24 are to be in open mode and/or shut mode (as well as possibly purge mode). Note that the one or more schedulers 78 (FIG. 2) provides this functionality.

(d) Data for partitioning a plurality of valve assemblies 24 so that for each partition, a common schedule applies to each of the valve assemblies in the partition. Note that each such partition (also denoted a “zone” herein) may be based on substantially any criteria the user desires; e.g., physical areas within a business establishment (such as a first zone having the valve assemblies 24 servicing a restaurant and a second zone having the valve assemblies 24 servicing an after hours bar). Note that the one or more zone controllers 80 provides this functionality. Thus, for one or more valve assemblies 24 in the first zone, these valve assemblies may be controlled by a first activation/deactivation schedule; e.g., placing these valve assemblies in the controlled mode when activated, and in the shut mode when deactivated. Additionally, for one or more different valve assemblies 24 in the second zone, these valve assemblies 24 may be controlled by a second potentially different activation/deactivation schedule. Accordingly, a first valve assembly 24 in the first zone can be active (e.g., in controlled mode) while a second valve assembly 24 in the second zone is inactive (e.g., in shut mode).

(e) Data for removing and/or aggregating one or more of the zones.

(f) Data for overriding a current schedule and thereby immediately placing one or more explicitly identified valve assemblies 24 into a desired mode for, optionally, a user input time duration.

Each of the valve control outputs from the controller 74 to a valve actuator 62 is output by one of the valve controllers 81. The valve controllers 81 construct the appropriate signal command (which may be a particular voltage) for transmitting, via connection 82b (described further hereinbelow), to a predetermined type of valve actuator 62. Accordingly, there may be different valve controllers 81 for different types of valve actuators 62.

Note that one or more of the connections 82a and 82b (FIGS. 1 and 2) between one of the user settable regulators 66 and a corresponding valve actuator 62 can be provided by various embodiments of the present invention. Regarding connection 82a, this connection. transmits valve mode transition commands from a controller 74 (FIG. 2) of the regulator 66 to the connected valve actuator 62 via a manual override 48. By activating the manual override 48 a user can manually override and change any current valve mode instruction provided automatically by the controller 74. Thus, for example, although the controller 74 may be configured to have a particular valve assembly 24 in the open or controlled mode for allowing its beverage to flow to a beverage dispenser 36, a user can override the controller 74 by entering a different instruction into the manual override 48, thereby instructing the valve actuator 62 (via connection 82a) to cause the valve assembly 24 to enter the desired different mode. Note that in embodiments of the present invention for dispensing beverages such as beer, that are contained in discrete containers (e.g., kegs), a user can use the manual override 48 to, e.g., request that the corresponding controlled valve assembly 24 be placed in the shut mode so that an empty keg can be replaced with a full keg, and once a new replacement keg is connected to its line 28, then the user can configure the manual override 48 so that the corresponding valve assembly 24 is, e.g., controlled by the beverage quality detector(s) 38 for determining whether the beverage in the line 28 should flow to a beverage dispenser 36, to the purge destination 40, and/or be shut off. Thus, the foam detector 54 causes one of its controlled valve assemblies 24 to enter the shut mode.

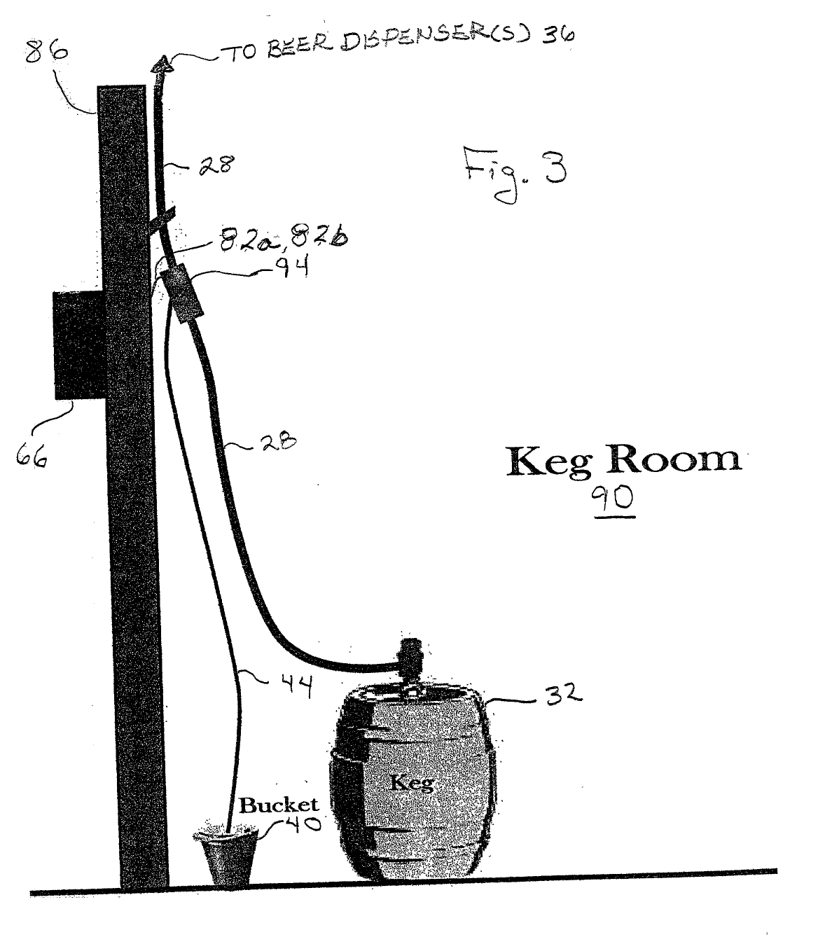

Note that in one embodiment of the beverage controller 20, the manual override 48 may be a simple toggle switch with two or more settings (e.g., a shut valve setting, a resume (any) control mode setting, and optionally: a setting for purging a line 28, and an for explicitly opening the valve assembly 24) as one skilled in the art will understand. Also, note that there may be a distinct toggle switch for each valve assembly 24. Accordingly, when the user settable regulator 66 is on-site with the beverage source(s) 32 and the beverage dispenser(s) 36, such a regulator (with, e.g., its one or override toggle switches 82) may be located on the outside wall 86 (FIG. 3) of a beverage storage room 90. In particular, FIG. 3 shows a beer keg room 90 from which beer is dispensed, wherein the connections (e.g., 82a and/or 82b) to each of the valve actuators 62 traverse the thickness of the wall 86. Moreover, note that in FIG. 3 the (single) valve actuator 62 and its controlled valve assembly 24 are provided in the same housing 94. Moreover, also provided in the housing 94 is a foam detector 54.

Regarding the connection 82b, this connection can be used for bidirectional transmission of signal data between a controller 74 and a valve actuator 62, wherein valve mode transition signals are provided to the actuator and operational status data is transmitted from the actuator 62 to the controller 74. Note that the connection 82b may be utilized when a user controls the beverage dispensing system 20 of the present invention remotely regardless of whether there is an on-site manual override or not (although such an on-site override 48 is generally preferable). In particular, a remote user may communicate with a user settable regulator 66 via remote control devices 96.

In one embodiment, such a remote control device 96 includes an interactive graphical user interface that allows a user to control the dispensing of a beverage by the beverage controller 20. Accordingly, when there is the ability for remotely controlling the beverage controller 20, the user settable regulator(s) 66 serves as an intermediary for establishing and maintaining communications with the remote device 96, and additionally, translating data and beverage controller regulating commands for subsequent communication to one or more of the valve actuators 62. Note, that in at least one embodiment of the invention, one or more of the valve actuators 62 can provide feedback to the user settable regulator 66 regarding, e.g., whether the actuator and/or a corresponding valve assembly 24 is functioning properly. Moreover, in some embodiments of the invention, a plurality of geographically disbursed beverage controllers 20 may be controlled remotely from a single site (not shown), wherein, e.g., the remote control device(s) 96 for each of the beverage dispensing systems 20 are integrated into a single user interactive software system which allows the user to open, close or purge various beverage lines 28. Additionally, the software system may allow the user to receive feedback regarding the amount (e.g., volume) of beverage dispensed via beverage meter(s) 98 further described hereinbelow.

Such remote control device(s) 96 may communicate with one or more regulators 66 utilizing one or more of:

(i) electrical, via alternating or direct current, providing electrical signals that are typical of small electrical components such as electronic sprinkler systems, and home/small business security systems. Accordingly, such a remote control device 96 may be dispensing console on a different floor of a hotel or casino from the user settable regulator 66, wherein there is, e.g., electrical wiring connecting the device 96 to the regulator 66;

(ii) a local area network (LAN), e.g., an Ethernet LAN, wherein the remote control device is attached to the LAN, and accordingly is likely to be in relatively close proximity to the regulator 66;

(iii) the public telephone system (wireline and/or wireless); e.g., the remote device 96 may communicate with the regulator 66 a standard (e.g., POTS) phone dialup connection of a public telephone network 100 (FIG. 2) and/or the Internet 104. Accordingly, the user may be located remotely from the site having the regulator 66 (and presumably the beverage source 32 and the beverage dispenser 36). However in such a case, at least the electronics (e.g., a modem) for receiving and maintaining such a phone call would likely be provided at the regulator 66 as one skilled in the art will understand;

(iv) a cable connection such as an optical cable; however similarly to (iii) above, at least the electronics for receiving valve regulating commands would likely be provided for the regulator 66 as one skilled in the art will understand; and/or

(v) a wireless connection such as is used for wireless communication between devices that are relatively near one another, such as home and/or business appliances. In particular, the BlueTooth communications protocol may be used.

Note that the functionality of the (any) manual override 48 as described hereinabove may be incorporated into an interactive user interface which, e.g., a user can utilize via a remote control device 96 for thereby overriding current beverage controller 20 settings. Further note that if both connections 82a and 82b are provided, there may be various override priorities established, e.g., between a remote user and an on-site user, or between an operator at a central beverage dispensing control center (e.g., in a large hotel or casino), and an operator who is, e.g., at a manual override 48 located at an beverage dispensing site. For example, in such a case, the manual override 48 may only be able to override any other valve operating modes for shutting a valve assembly 24, for purging a line 28, and/or for resuming valve assembly 24 operation according to a previous set of criteria such as a previous schedule, and/or an amount of beverage to be dispensed. Accordingly, in addition to the valve transition modes provided hereinabove, at least the present embodiment of the invention may also include components (both hardware and software) for resuming a previous valve assembly 24 activation/deactivation schedule or other previously provided valve assembly controlling criteria such as a maximum amount of beverage to be dispensed, or a maximum expense to be incurred for the beverage(s) dispensed at a planned event.

Embodiments of the invention may also include additional/modified components for recognizing and processing valve mode transition commands. For example, the controller 74 and/or a valve actuator 62 may include components (hardware and/or software) that:

(a) Determine an identification of the source of valve control related signals; e.g., a supervisor providing beverage control input from a first input device (either on-site or otherwise) via the controller 66, or an on-site operator on-site operator providing input via the manual override 48.

(b) A prioritization between signal source for various valve mode transitions, wherein, e.g., a signal from an on-site manual override 48 for shutting a valve assembly 24 takes precedence over a beverage dispensing schedule provided by a supervisor or remote user.

Such additional/modified components may reside at least partially at the valve actuator 62. Additionally note that for performing at least (b) immediate above, instead of the manual override 48 transmitting control signals to a valve actuator 62, such control signals are re-routed to the controller 74 so that the controller 74 can perform substantially all processing related to determining when and what valve mode transition commands are transmitted to a valve actuator 62. Thus, in this embodiment, all communication with the valve actuator(s) 62 is via connection 82b.

Optionally included in embodiments of beverage dispensing system 20 is one or more beverage meters 98, wherein each such meter 98 meters the amount of a beverage passing through a beverage line 28 monitored by the meter. Typically, if such beverage meters 98 are provided, there is one such meter for each different type of beverage being dispensed by the beverage controller 20 at a given site (e.g., a restaurant, bar, and/or mobile beverage dispensing unit). Such a meter 98 may communicate, via channel 108 with the user settable regulator 66 for, in turn, transmitting data related to the amount of a beverage dispensed to a user and/or automatically to a data store 112 (FIG. 2) for subsequent processing and/or display. Alternatively, such meters 98 may not transmit data about the amount of a beverage dispensed. In particular, one such meter 98 may be a substantially mechanical flow meter having an electromechanical display that must be manually read at the meter, as one skilled in the art will understand. The present invention may be used with various commercially available meters 98. However, most such meters can not distinguish between a substantially liquid volume passing through a line 28 and, e.g., substantially foam and/or air passing through the line. Thus, since for most beverages, foam and/or air is considered undesirable, having a foam detector 54 (FIG. 2) as one of beverage quality detectors 38 is particularly advantageous for more accurately determining the amount of a beverage that has been dispensed through a line 28 that is being metered by a beverage meter 98.

Returning now to the controller 74, it also includes a power unit 116 for receiving conventional electrical power from an external source, e.g., a 110 volt source, and transformed to an appropriate voltage such as 5 to 10 volts. Once the electrical power is received and transformed, it may be converted via converter 120 from alternating current (AC) to direct current (DC), or visa versa. Subsequently, the resulting electrical power is provided to the other components of the regulator 66. Note, however, that also included may be a one or more failsafe components 124 for assuring that power outages and/or electrical power anomalies (e.g., power spikes) do not adversely effect the operation of the regulator 66.

It is within the scope of the present invention that the user settable regulator 66, and in particular the controller 74, can have embodiments with wide variations in functionality. In particular, in one relatively simple embodiment, the regulator 66 may include a controller as, for example, is manufactured by RainBird Sprinkler Manufacturing Corp., 6640 South Bonney Ave., Tucson, Ariz. 85706 Inc., model number ESP6LXI+ which is also used as a controller for sprinkler systems.

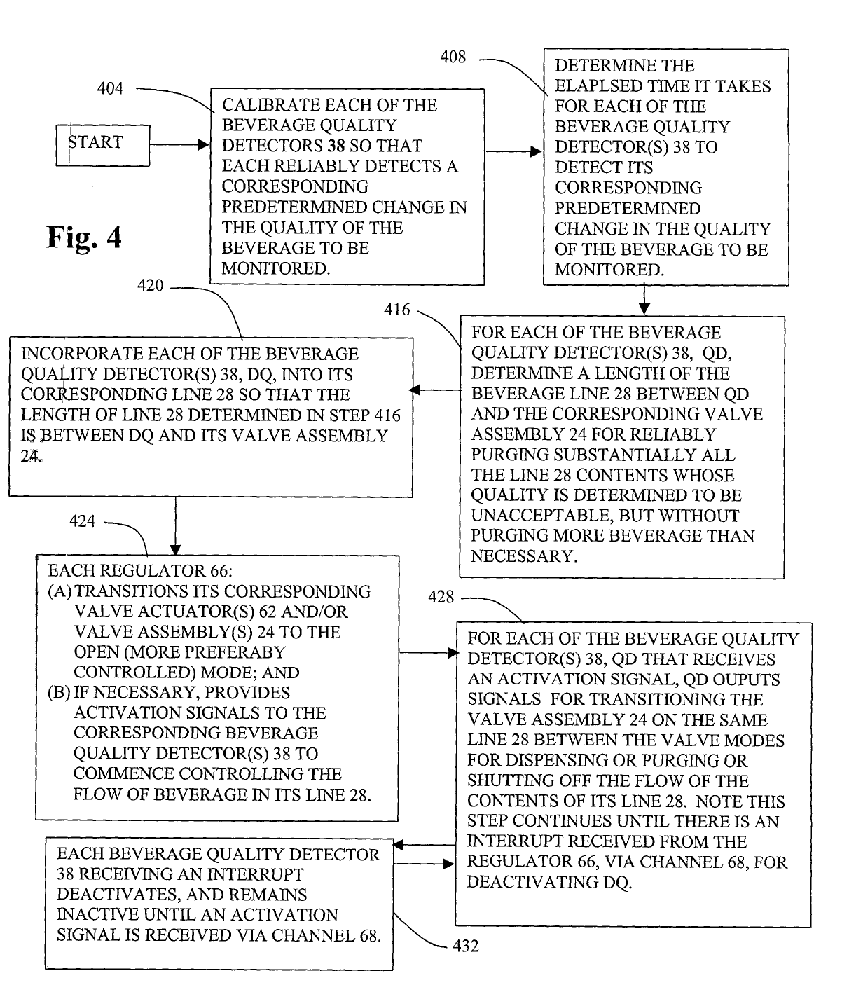

FIG. 4 is a high level flowchart of the steps performed in configuring an operable embodiment of the beverage dispensing system 20 as represented in FIG. 1, and subsequently operating the configured embodiment. In step 404 each of the beverage quality detectors 38 is calibrated so that it reliably detects the beverage quality characteristics for which it is intended. Of course it may be that at least some of the quality detectors 38 do not require calibrating. However, for many electronic quality detectors having signal processing components calibration is likely necessary. For example, certain beer foam detectors (as described hereinbelow) may require such calibration. Additionally, beverage quality detectors 38 that detect, e.g., water quality (water being the beverage) may require such calibration according to the minerals and chlorine content variations that may present in the water. In step 408, for each of the quality detectors 38 an elapsed time is determined for how long it may take a quality detector 38 to detect a change in the contents of the beverage line 28 being monitored. In step 416, a length of the line 28 to be monitored is determined for placing between the quality detector and the corresponding valve assembly 24 so that substantially all of the line contents whose quality is determined to be unacceptable is appropriately purged via the valve assembly, but with purging substantially only the unacceptable contents of the line 24. Note that such a determination is dependent upon both the elapsed time required by a quality detector and the speed of the beverage flow. Subsequently in step 420, incorporate each of the quality detectors 38 into its line 28 so that there is the corresponding length determined in step 416 between the quality detector and it corresponding valve assembly 24. In step 424, each of the regulators 66 for which instructions have been received (e.g., by a user) activates control of one or more of its valve assemblies 24, and (at least in some embodiments of the invention) the corresponding beverage quality detector(s) 38. Note that the beverage quality detector(s) 38 may be activated sufficiently prior to their valve assemblies 24 so that an initial beverage quality determination may be made prior to the valve assembly being put in the open or controlled mode so that if the beverage is initially unacceptable it can be immediately purged. Note that in some embodiments of the present invention, there may be no channel 68 that would allow the regulator 66 to activate a quality detector 38. In such cases, it is likely that a user will have to manually activate the quality detector prior to instructing the regulator 66 to activating the valve assembly 24 controlled (i.e., corresponding) to the quality detector. In step 428, each of the activated quality detectors 38 monitors its beverage line(s) 28 until a deactivation signal is received from, e.g., its controlling regulator 66. Of course in the case where there is no such controlling regulator 66 (e.g., there is no channel 68), such an interrupt may be in the form of a user manually deactivating (e.g., turning off) the quality detector. Subsequently, any such deactivated quality detectors 38 may be reactivated in which case each one once again may enter a state for actively controlling the quality of the beverage being monitored.

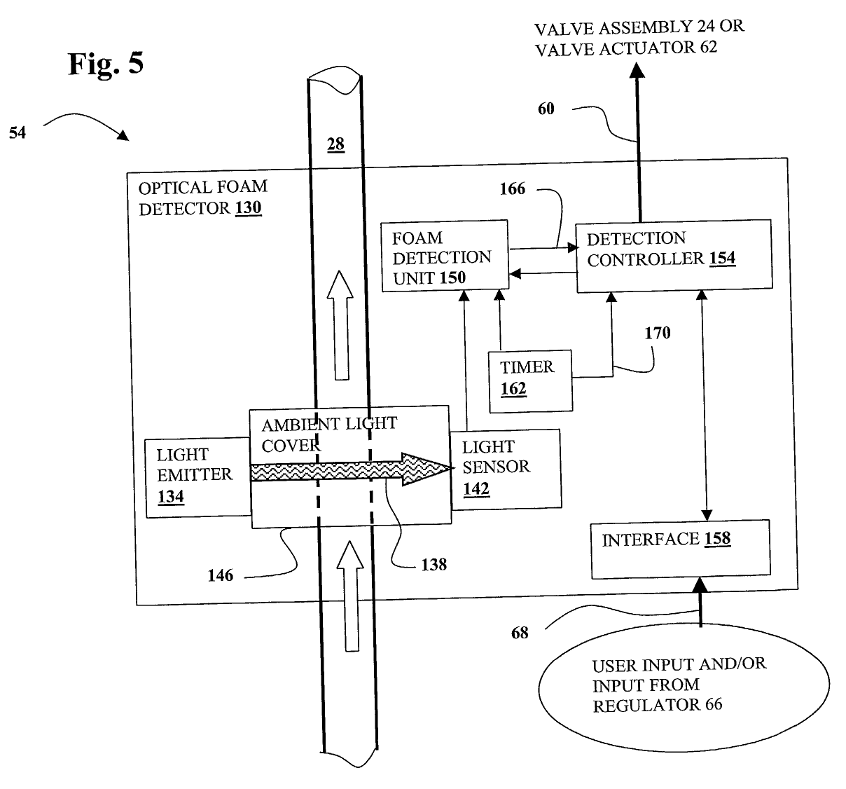

Additionally, note that in some embodiments of the beverage dispenser 20, a particularly important foam detector 54 can be provided, wherein this foam detector (denoted the optical foam detector 130 herein) optically detects changes according to whether there is foam in one of the lines 28 monitored by detector 130. FIG. 5 shows a high level diagram of the components of an embodiment of the optical foam detector 130. In particular, the detector 130 includes a light emitter 134 such as a diode for transmitting light 138 through the beverage line 28 which, at least in the region where light 138 is transmitted, the line 28 is transparent. On an opposite side of the line 28 is a light sensor 142 positioned for sensing the light 138 when it is neither diffracted nor reflected. Note that the light emitter 134 and the light sensor 142 are commercially available optical components such as is manufactured by Optech Technology Inc., 1215 W. Crosby Road, Carrollton, Texa. 75006 (e.g., model number OP140A for the emitter 134, and model number OPL563 for the sensor 142). In the intervening space between the light emitter 134 and the light sensor 142 is an ambient light cover 146 for inhibiting ambient light reflections from causing the light sensor 142 to erroneously sense light reflected and/or deflected light. The light sensor 142 outputs a voltage proportional to the light 138 detected. This output voltage is provided to a foam detection unit 150 for determining whether a sufficient quantity of foam is detected to subsequently output a signal to either the attached valve assembly 24 and/or the corresponding valve actuator 62 requesting that the contents of the line 28 is to be either purged via purge line 44, or shut thereby stopping the beverage flow. Note that when the beverage is beer, the optical distinction between substantially foam and substantially beer in the line 28 may be described as follows: the bubbles in the foam act effectively as mirrored surfaces that reflect the (infrared) light emitted from the light emitter 134 so that a reduced amount of light is sensed at the light sensor 142. Note that in one embodiment of the invention the light sensor 142 has a sensitivity irradiance of 9 mW/cm², and the emitter 134 emits light in the range of approximately 935 nm. Accordingly, note that the foam detection unit 150 includes one or more of the following values for comparing and/or analyzing the inputs received from the light sensor 142: values (e.g., voltages) indicative of sensed light intensity when foam is present in the line 28, values (e.g., voltages) indicative of the sensed light intensity when the beverage is present in the line 28, values indicative of the light frequencies sensed when foam is present in the line 28, and/or values (e.g., voltages) indicative of sensed light frequencies sensed when the beverage is present in the line 28. In particular, various embodiments of the foam detection unit 142 may use these values for determining whether the contents of the line 28 is substantially foam or substantially beverage. Note that in one embodiment, when foam is detected by the foam detection unit 150, a 12 volt signal is output to the detection controller 154.

Moreover, it is important to note that since beverages vary in their optical characteristics, the values used by the foam detection unit 150 may need to be predetermined via a calibration process. One such calibration process is as follows: (a) determine the acceptable amount of foam line 28 that can be allowed to pass through the line 28; (b) determine the range in opacity of the beverages to be monitored for foam; and (c) for each of the beverages to be monitored, adjust the intensity of the light emitted by the emitter 134 so that a predetermine minimum amount of foam in line 28 (e.g., 4 feet of line 28) causes a sufficient number light sensor 142 outputs to be indicative of foam.

Note that in one embodiment of the invention, the values used by the foam detection unit 150 for determining beverage versus foam may be input to the foam detector interface 158 discussed further hereinbelow. Accordingly, upon use of the present invention for detecting foam in a line 28 having a beverage therein for which foam has not been previously been detected, the optical foam detector 130 may need to be calibrated by inputting to the line 28 various combinations of foam and the beverage for properly setting the values

Upon the foam detection unit 150 detecting a change in the contents of the line 28 from either substantially all beverage to substantially foam, or from substantially foam to substantially all beverage, the foam detection unit outputs a signal to the detection controller 154 that is indicative of such a change. Accordingly, the detection controller 154 then outputs a signal to either of the attached valve assembly 24 and/or the corresponding valve actuator 62 for switching between allowing the beverage to be dispensed and allowing the beverage to be purged.

Additionally the detection controller 154 also receives data from an interface 158 that, in turn, receives external input from, e.g., a user and/or the regulator 66. Such external input may be calibration values such as the elapsed time that an optical change must be sensed at the light sensor 142 before the foam detection unit 150 outputs a signal indicating a change in the contents of the line 28. In one embodiment for the detecting of foam in a beer line, such an elapsed time has been determined to be in the range of 1/12 to ¼ of a second for a ⅜ inch diameter beer line 28. Thus, when the detection controller 154 receives such timing calibration values, it provides these values to the foam detection unit 150 so that this unit can count timing signals output by the timer 162. It is important to note that as with many signal processing applications, there can be transient signal anomalies output by the light sensor 142, wherein, e.g. in the midst of a relatively consistent series of voltage samples indicative of a change in the contents of the line 28 voltage outliers may also be detected. Accordingly, the foam detector unit 150 performs signal processing tasks for removing and/or mitigating (e.g., smoothing) the effects of such outliers. For example, the foam detection unit 150 may:

(a) Average or merely add samples in a moving window of voltage samples obtained from the series of voltage samples output by the light sensor 142. That is, such averaging or summing occurs on each instance of a window of the voltage samples as the window moves through the series as one skilled in the art will understand; and/or

(b) Detect and remove voltage outliers from the voltage samples by one or more statistical techniques such as determining the standard deviations of each window of voltage samples, and not using a next voltage sample for determining if a change in the state of foam within the line 28 has taken place if this next voltage sample is outside of the window's standard deviation. However, this next voltage sample is still used in subsequent moving windows to which it is applicable.

Of course other signal processing techniques well known in the art may also be utilized by the foam detector unit 150.

At least for most beers, and for at least some embodiments of the invention, Applicant's have determined that a voltage buffer receiving output from the light sensor 142 may be used for mitigating outliers in such output. In particular, the voltage buffer accumulates or sums digital samples received from the light sensor 142 until a predetermined capacity is reached. When such capacity is reached, then a signal is output to the detection controller 154 for subsequently providing a signal output to the valve actuator 62 and/or valve assembly 24. Note when the buffer provides the output signal to the detection controller 154, the buffer is then reset.

Note that the typical operating conditions for the dispensing of beer is 38 to 45 degrees F, and 18 and 30 psi. Accordingly, so that there may be very little beer wasted due to purging, as well as providing a substantial reduction in the amount of foam that is dispensed at a beverage dispenser 36, the speed at which the optical foam detector 130 detects a change in the foam state in the contents of the line 28 may be matched with the length of the beverage line between the optical foam detector 130 and the valve assembly 24 for the same line. In particular, for typical beers being dispensed under typical operating conditions, the elapsed time range of 1/12 to ¼ seconds disclosed above corresponds to a line 28 length of approximately 3 to 9 inches between the optical foam detector 130 and the corresponding valve assembly 24. However, note that longer lengths of line 28 may also be provided between the between the optical foam detector 130 and the corresponding valve assembly 24. Accordingly, there may be two elapsed times used by the optical foam detector 130, i.e., the elapsed time value as discussed above for reliably identifying a foam state change in the contents of the line 28, and additionally, a delay time, DT, corresponding to the length of time it will take the detected changed contents of the line 28 to reach the valve assembly 24 when this assembly has a greater length of beverage line 28 between the detector and the valve assembly. Note that since each delay time period for DT is determined by the detection controller 154 once the foam detection unit 150 provides a signal (on channel 166), then the detection controller 154 accesses the (any) value DT and commences counting timing signals received from the timer 162 (via channel 170) until the time delay has expired at which time the detection controller 154 transmits valve mode transition information on the channel 60. By including such a purposeful time delay DT, the valve assembly 24 can be provided substantially anywhere on its line 28 equal to or further away than the length of line corresponding to the elapsed time. Thus, such a valve assembly may be placed along its line 28 where it is convenient; e.g., where there is a nearby purge destination 40 such as a drain and/or recycling facility.

Various alternative embodiments of the optical foam detector 130 are within the scope of the present invention. For instance, instead of measuring non-reflected and non-deflected light, an alternative embodiment may measure these light characteristics for detecting a change in the line 28 foam state. Thus, instead of the light sensor 142 being directly opposite the light emitter 134, one or more light sensors 142 may be distributed about the line 28 for detecting reflected and/or deflected light from the light emitter 134.

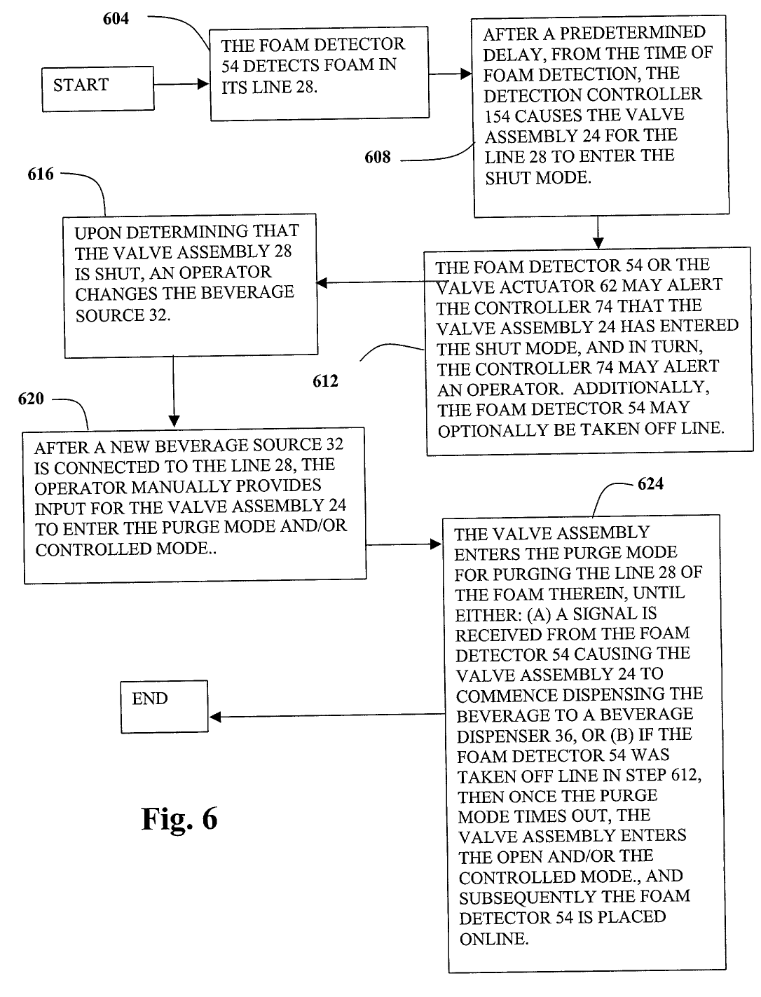

FIG. 6 is a flowchart showing the steps performed by an embodiment of present invention when a foam detector 54 detects an undesirable amount of foam its line 28 which is due to the currently connected beverage source 32 (e.g., a beer keg) being substantially depleted of it beverage, and accordingly must be replaced. Thus, in step 604, the foam detector 54 (more precisely the foam detection unit 150) detects a sufficiently prolonged change in the optical characteristics of the contents of the line 28 to indicate that there is an undesirable amount of foam therein. Accordingly, the detection controller 154 is notified, and in step 608 after the predetermined delay time DT elapses, the detection controller 154 notifies at least one of: the corresponding valve actuator 62 and/or the valve assembly 24 for the line 24 so that this valve assembly can enter the shut mode thereby preventing any further beverage from flowing past the valve assembly. Subsequently, in step 612, the foam detector 54 may (if the embodiment of the invention has such capabilities) alert the controller 74 that the valve assembly 24 has entered the shut mode, and in turn, this controller may alert one or more operators that foam has been detected in the line 28. Note that such alerts may be to a local operator and/or a remote operator. Eventually, an operator arrives to determine what is causing the foam, which for beer in most cases is due to a depleted keg. Moreover, once an operator has determined, e.g., the current beverage source 32 needs replacing, he/she may provide input to the manual override 48 for explicitly shutting the valve assembly 24 thereby assuring that the valve assembly remains shut while the current beverage source 32 is replaced by a new one. Note that in at least one alternative embodiment for step 612, the foam detector 54 is deactivated (taken offline) by the valve actuator 62 and/or the valve assembly 24 via channel 60 as mentioned hereinabove. Subsequently in step 616, upon determining that the valve assembly 24 is shut (and will remain shut), the operator changes the beverage source 32 containers. Then, in step 620, once the new beverage source 32 is connected to the line 28, the operator manually (via the manual override 48) provides input for the valve assembly 24 to enter one of the purge mode or the control mode. Note that the mode selected here depends on, e.g., the capabilities of the foam detector 24. For example, if the foam detector 24 only provides signals for opening the valve assembly to a beverage dispenser 36 and shutting the valve assembly, then the operator must explicitly request that the valve assembly 24 be put in the purge mode. Alternatively, the operator may put the valve assembly 24 in control mode if the foam detector 24 obtains or retains sufficient information about the state of the valve assembly 24 and is able to also send requests for the valve assembly 24 to enter the purge mode (until no foam is detected and then enter the controlled mode where the beverage flows to the beverage dispenser 36). In any case, in step 624, the valve assembly 24 now enters the purge mode for purging the line 28 of the foam therein, and such purging continues until either (a) a signal is received from the foam detector 54 for causing the valve assembly 24 to commence dispensing the beverage to a beverage dispenser 36, or (b) if the foam detector 54 was deactivated in step 612, then once the purge mode times out, the valve assembly 24 enters the open and/or control mode, and subsequently the foam detector is activated for detecting foam.

For various beverages, such as beer, and/or other carbonated drinks, it is desirable to have a portable or mobile embodiment of the present invention, wherein the components 24 through 94, 98, 108, 112 through 162, if provided, are ncorporated into the portable beverage dispensing unit. Note that the above description of the invention is applicable to such a portable embodiment. However, in portable embodiments it may be particularly desirable that there be a wireless connection to a network 100 and/or 194 for remotely monitoring. Moreover, such portable embodiments of the invention may have relatively limited amounts of the beverage source(s) 32, such as a portable unit for dispensing beer and/or carbonated beverages, wherein such a unit may be provided to small events within a hotel. Accordingly, beverage quality detectors 38 such as the foam detector 54, may be in signal communication (via channel 68) with a regulator 66 of the portable unit, and the regulator 66 may then wirelessly contact one of the remote control device(s) 96 when a malfunction occurs at the portable unit such as one of the beverage sources becomes depleted. Note, such wireless monitoring may reduce personnel costs an attendant need not be provided with the portable unit.

As mentioned above, the present invention is useful for dispensing beer and other carbonated beverages. However, other beverages such as coffee and tea may also be distributed by embodiments of the invention. Additionally, as also mentioned above, the present invention can used for enhancing and/or assuring water of an appropriate quality is distributed throughout a populated area (e.g., a metro-area). Accordingly, one or more valve assemblies 24 may be provided at a water treatment plant and/or distributed throughout a water distribution network for purging and/or recycling water detected as unacceptable for distribution.

The present invention is also applicable to dispensing and/or distributing other liquids besides beverages, where it is preferred that the quality of the liquid is determined before final distribution. For example, oil, carbonated water, milk products, syrups, wine, cooking oils, liquid dough, liquid medicines, liquid pesticides, liquid herbicides, automotive oils, natural and synthetic oils, liquid soap, and grease (both industrial and eatable).

The foregoing discussion of the invention has been presented for purposes of illustration and description. Further, the description is not intended to limit the invention to the form disclosed herein. Consequently, variation and modification commensurate with the above teachings, within the skill and knowledge of the relevant art, are within the scope of the present invention. The embodiment described hereinabove is further intended to explain the best mode presently known of practicing the invention and to enable others skilled in the art to utilize the invention as such, or in other embodiments, and with the various modifications required by their particular application or uses of the invention. It is intended that the appended claims be construed to include alternative embodiments to the extent permitted by the prior art.

What is claimed is:

1. A method for dispensing a product, comprising:
receiving first input indicative of a time for activation of a first valve assembly through which the product is dispensed so that the product can be dispensed for a time period following the time;
monitoring at least one characteristic of the product while it is being dispensed through said first valve assembly for outputting an indication of a quality of the product;
changing a first configuration of said first valve assembly to a different second configuration when said step of monitoring determines that a predetermined change in the at least one characteristic of the product occurs, wherein said first and second configurations each allow one of the following substeps (a) through (b) to be performed:
(a) first dispensing the product to a first destination when said quality is satisfactory, and
(b) prohibiting a dispensing of the product to the first destination when one of: said time period has elapsed, and said quality is unsatisfactory;
second dispensing the product to a second source when said quality is unsatisfactory while performing said step of monitoring.

2. The method of claim 1, wherein the product includes a drinkable liquid.

3. The method of claim 2, wherein the at least one characteristic includes foam.

4. The method of claim 3, wherein said first source dispenses the product to preferred destination, and said second source purges or recycles the product.

5. The method of claim 4, further including:
partitioning a plurality of valve assemblies into a plurality of different zones, wherein said first valve assembly is in a first of said zones not including a second valve assembly, said second valve assembly in a second of said zones;
receiving second input indicative of a time for deactivation of said second zone for inhibiting a dispensing of the product therefrom;
storing first data indicative of said first input, and second data indicative of said second input;
using said first data for activating each valve assembly in said first zone;
using said second data for deactivating said valve assemblies in said second zone while said first valve remains active.

6. The method of claim 4, wherein the product includes beer, and said step of monitoring includes activating a foam detector having a predetermined time delay between a time of detecting a foam in the beer and a performing of said step of changing.

7. The method of claim 1, wherein said step of monitoring includes detecting a change in an optical characteristic of the product, and as a result of said step of detecting, performing said step of changing.

8. The method of claim 1, further including notifying a remote operator when said step of monitoring determines that the product has an unsatisfactory.

9. The method of claim 1, wherein said step of changing includes a step of receiving a signal from a foam detector.

10. A method for detecting foam in a beverage, comprising:
determining an optical distinction between foam and the beverage;
transmitting light through a contents having one of the beverage and foam;
using said distinction for identifying the contents;
when said contents is identified as foam, sending a signal for changing a configuration of a valve assembly to prohibit a dispensing of the beverage to a first destination.

11. The method of claim 10, wherein said step of determining includes detecting a light intensity change.

12. The method of claim 10, wherein said step of using includes determining a length of time that the foam is substantially detected.

13. The method of claim 10, wherein the beverage includes beer.

14. The method of claim 10, further including purging the contents when the contents is identified as substantially foam.

15. The method of claim 10, further including determining a delay time for delaying said signal.

16. A beer foam detector, comprising:
a light emitter and sensor for detecting light emitted by said light emitter;
a transparent portion of a beer line positioned in proximity to said light emitter and said light sensor, wherein said sensor detects light that traveled through said transparent portion;
a comparator for comparing: (a) signals output by said sensor that are indicative of the light detected by the sensor, and (b) at least one predetermined value that is indicative of whether a contents of said transparent portion is foam or beer;
a transmitter for transmitting a signal indicative of a change in the contents of the transparent portion between one of foam and beer.

17, The beer foam detector of claim 16, wherein said light emitter includes a diode.

18. The beer foam detector of claim 16, wherein said transparent portion is between said light emitter and said sensor.

19. The beer foam detector of claim 16, wherein said comparator sums a series data items indicative of voltages received from said sensor.

20. The beer foam detector of claim 16, further including a timer for determining an elapsed time that one of foam and beer must be substantially continually detected by said comparator before the contents is identified.

21. The beer foam detector of claim 16, further including a timer for determining a delay time for delaying the transmitting of said signal.
